(19) United States
(12) Patent Application Publication
(10) Pub. No.: US 2024/0196935 A1
(43) Pub. Date: Jun. 20, 2024

(54) Fruit Beverage Concentrate Composition

(71) Applicant: Charlie Glass, New Orleans, LA (US)

(72) Inventor: Charlie Glass, New Orleans, LA (US)

(21) Appl. No.: 18/587,466

(22) Filed: Feb. 26, 2024

(51) Int. Cl. A23L 2/385; A23F 3/16; A23L 2/02; A23L 2/60

(52) U.S. Cl. CPC A23L 2/385; A23F 3/16; A23L 2/02; A23L 2/60

(57) ABSTRACT

A fruit beverage concentrate composition which is suitable for thawing and dilution for human composition includes natural and organic components which consists of sugar granules, sieved powdered tea, orange peach flavor, pineapple juice, water, and a fruit juice which can be one of mango juice or peach juice. The composition is stored in a gallon pitcher in a refrigerator for freezing where it becomes frozen in about two hours, and the frozen tea beverage concentrate composition exhibits a longer shelf life. The frozen composition is preferably diluted for human consumption with an addition of water, and it provides several advantages including improved flavors, consistency, and aroma.

### BACKGROUND OF THE INVENTION

### Field of the Invention

The present invention relates generally to fruit beverages and more particularly to a fruit beverage concentrate composition.

### Description of the Related Art

Many people prefer tea beverages and both hot and cold tea beverages are popular among consumers. Many consumers prefer tea forms that are readily or easily prepared. The preferences are typically due to convenience factors, as ready-made tea saves time and effort compared to traditional tea brewing methods. Some teas are available in bottled forms, which allow for easy transport and consumption outside the home.

However, traditional tea beverages do not include fruity flavors and desired consistencies and aromas. Tea beverages infused with natural fruit flavors and aromas that can cater to consumers seeking variety and a different taste profile are not available commercially. Also, many conventional tea beverages that are pre-packaged as frozen concentrates do not incorporate the health benefits of natural juices and fruits while also providing the desired aromas.

Many liquid tea beverages or concentrates do not remain high in quality over a period of time. This is due to the chemical properties of tea or caffeine and interactions with other ingredients included in the beverage. As a result, conventional tea beverages are difficult to properly freeze and dilute, resulting in a short shelf life and overall less quality.

In many scenarios, the remaining quantity of liquid tea beverages after use is required to be disposed of which is not only frustrating but also expensive. Further, thawing of existing frozen tea concentrates results in a beverage without the desired aromas and flavors.

None of the existing tea beverages and associated compositions provide a convenient, effective, and efficient way to create, freeze, and dilute, as well as increase the shelf life of the tea beverage, while also providing natural and fruity tastes and wanted aromas.

A need exists for a new type of frozen tea beverage that has the inclusion of natural fruit flavors, which can be frozen and diluted as per the requirements of consumers, and which provides for an increased shelf life, while also providing the health benefits of natural juices and fruits.

None of the conventional tea beverages disclose the unique advantages and characteristics of the present disclosure. The tea beverage composition disclosed herein overcomes many of the drawbacks of conventional tea beverages.

Accordingly, there is a need for an improved frozen tea beverage concentrate composition with an increased shelf life and that is suitable for thawing and dilution to generate a beverage suitable for human consumption.

It is one prospect of the present invention to provide a novel frozen tea beverage concentrate composition that can be thawed and diluted to generate a beverage suitable for human consumption and that provides health benefits to the consumers, while providing improved aromas and flavors as desired by the consumers.

Another object of the present invention is to provide a frozen tea beverage concentrate composition that contains natural fruit juices. Yet another object of the disclosed invention is to provide a frozen tea beverage concentrate composition suitable that can be diluted using water for human consumption.

Yet another object of the disclosed invention is to provide a tea beverage concentrate composition that can be frozen inside a refrigerator and provide for an improved shelf life.

As disclosed in this application, the inventor has discovered a novel and unique frozen tea beverage concentrate composition suitable for thawing and dilution to generate a beverage suitable for human consumption, where the disclosed frozen tea beverage concentrate composition provides uncompromised flavor profiles and health benefits.

Embodiments of the present invention provide for a frozen tea beverage concentrate composition as described and defined in the description below and in the annexed claims which provide for improved taste, shelf life, and effectiveness characteristics in order to conveniently and more effectively provide a tea beverage for human consumption.

### SUMMARY OF THE INVENTION

The following presents a simplified summary of the present disclosure in a simplified form as a prelude to the more detailed description that is presented herein.

Therefore, in accordance with embodiments of the invention, there is provided frozen tea beverage concentrate composition. The frozen tea beverage concentrate composition consists of sugar, powdered tea, orange peach fruit, pineapple juice, water, and a fruit juice in the form of mango juice or peach juice. The frozen tea beverage concentrate composition is pureed and then frozen in a freezing device for at least two hours. Additional water is added to the frozen composition for diluting the composition for human composition.

Preferably, the fruit beverage concentrate composition that is suitable for thawing and dilution configured to generate a beverage suitable for human consumption, consists of the following components, as follows: sugar is 2%-3% by weight, the powdered tea is 4%-6% by weight, the orange peach fruit is 20%-21% by weight, the pineapple juice is 5%-6% by weight, the water is 60%-61% by weight, and the fruit juice is 4%-6% by weight. The fruit beverage concentrate composition is first pureed and then frozen in a freezing device for at least two hours.

In a preferred embodiment, the composition is diluted with about 55% by weight to about 56% by weight water to prepare the beverage suitable for human consumption.

In a preferred embodiment, the sugar is one of white sugar and brown sugar and is in the form of granules.

In one embodiment, the powdered tea passes through a U.S. mesh sieve number 40 prior to being added, when a user forms the composition in accordance with embodiments disclosed herein.

In another embodiment, the fruit beverage concentrate composition includes 4 oz sugar, 8 oz powdered tea, 32 oz orange peach flavor, 8.4 oz pineapple juice, 92 oz water, and 8 oz mango or peach juice.

In another embodiment, the 84 oz water is used for diluting the composition.

In yet another embodiment, the composition contains about 1% by weight to about 3% by weight sugar, about 5% by weight to about 8% by weight powdered tea, about 16% by weight to about 23% by weight orange peach fruit, about 4% by weight to about 7% by weight pineapple juice, about 50% by weight to about 71% by weight water, and about 5% by weight to about 8% by weight a fruit flavor.

In yet another embodiment, a method of making a frozen tea concentrate beverage composition is provided where the composition is configured for thawing and dilution to generate a beverage suitable for human consumption. The method includes providing 4 oz sugar, 8 oz powdered tea, 32 oz orange peach flavor, 8.4 oz pineapple juice, 92 oz water, and 8 oz mango or peach juice. The method also includes mixing the 4 oz sugar with the 8 oz powdered tea, adding the 32 oz orange peach flavor to form a first mixture, adding 8.4 oz pineapple juice to form a second mixture. The method further includes mixing the second mixture with 92 oz water, adding 8 oz mango or peach juice to the second mixture to form the composition. In one embodiment, the method preferably includes pouring the composition in a gallon pitcher, placing the gallon pitcher in a freezing device for freezing the composition. In another embodiment, the method preferably includes thawing the frozen composition including diluting the frozen composition by adding water 84 oz to the frozen composition.

In a preferred embodiment, the composition is frozen for a predetermined length of time, wherein the predetermined length of time is at least 2 hours.

In one embodiment, the powdered tea is preferably poured through a sieve consisting of U.S. mesh sieve number 40 wherein the powdered tea is 4%-6% by weight and consists of particle sizes passed through said U.S. mesh sieve number 40.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 illustrates a block diagram showing ingredients of the frozen tea beverage concentrate composition of the present invention, in accordance with embodiments of the invention;

FIG. 2 illustrates ingredients of another composition of the frozen tea beverage concentrate of the present invention, in accordance with embodiments of the invention;

FIG. 3a illustrates a perspective view of producing a first mixture, in accordance with embodiments of the invention;

FIG. 3b illustrates another perspective view of producing a first mixture, in accordance with embodiments of the invention;

FIG. 4 illustrates a perspective view of mixing water into the first mixture to produce a second mixture, in accordance with embodiments of the invention;

FIG. 5 illustrates a perspective view of freezing the composition to produce the preferred frozen tea concentrate beverage composition, in accordance with embodiments of the invention; and

FIG. 6 illustrates a flow chart of a method for making a making a frozen tea concentrate beverage composition that is adapted for thawing and dilution in order to generate a beverage suitable for human consumption, in accordance with embodiments of the invention.

### DETAILED DESCRIPTION

For a further understanding of the nature and function of the embodiments, reference should be made to the following detailed description. Detailed descriptions of the embodiments are provided herein, as well as the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

The terms “about” and “approximately” as used herein, indicate that the precision of the nominal value presented is +5%.

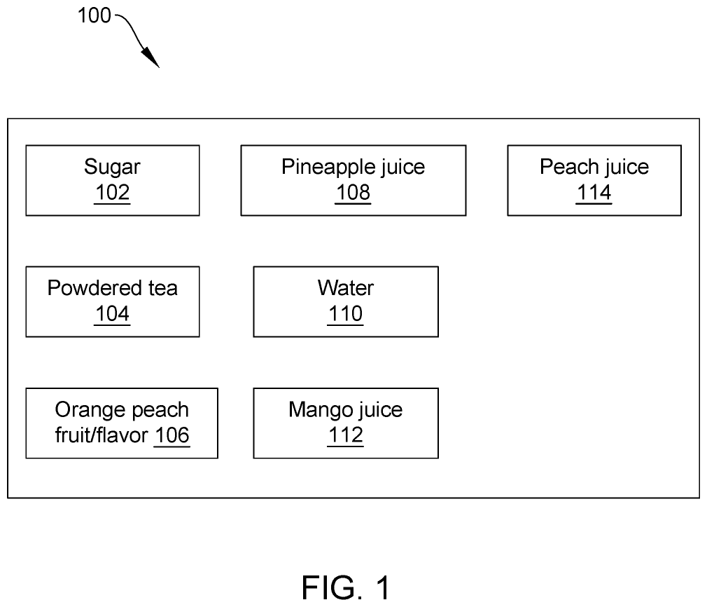

As illustrated in FIG. 1, in a preferred embodiment, the frozen tea beverage concentrate composition 100 includes sugar 102, powdered tea 104, orange peach fruit/flavor 106, pineapple juice 108, water 110, and one of mango 112 or peach juice 114. The concentrate composition 100 is suitable for human composition and can be diluted using additional water 110 for such consumption. Suitable for human consumption means safe for people to ingest, meaning to eat or drink, without harmful effects. More specifically, the frozen tea beverage concentrate composition 100 is frozen in a freezing device 502 for at least a predetermined time period, such as two hours, and the composition 100 is preferably pureed before being placed inside of the freezing device 502 for freezing.

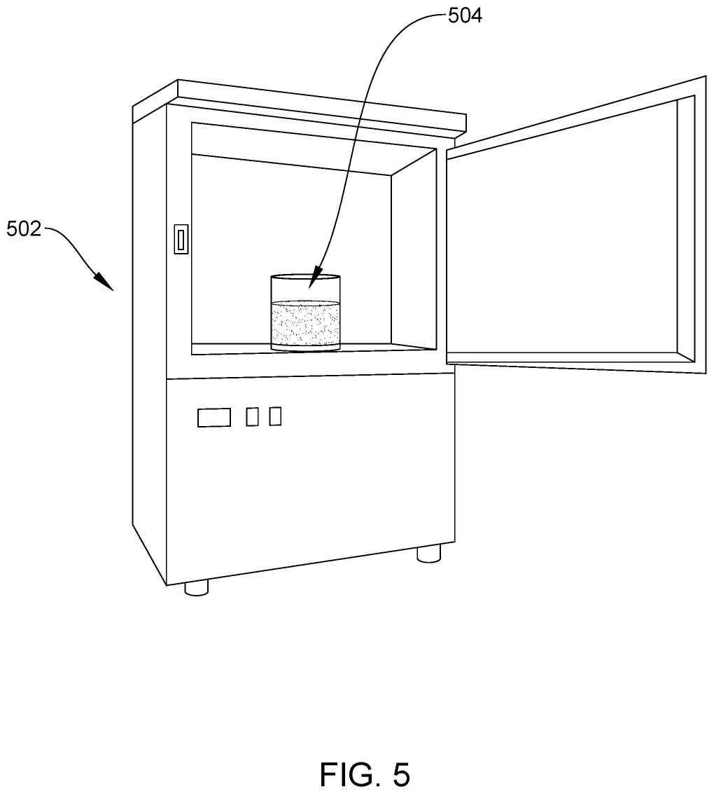

As shown in FIG. 5, the composition 100 is preferably stored in a storage device such as a gallon pitcher 504 that is placed inside of the freezing device 502 (preferably for at least two hours) for freezing the composition 100.

The sugar 102 can be one of white sugar and brown sugar and is preferably in the form of granules. In some embodiments, the sugar 102 can also be in the form of a powder. The orange peach fruit 106 is preferably natural but can also be commercially available orange peach fruit 106. In a preferred embodiment, the powdered tea 104, 204 can pass through a U.S. mesh sieve number 40 302, as such filtering provides an improved aroma of the frozen tea beverage concentrate composition 100.

Table 1 below shows approximate concentrations of various components in the frozen tea beverage concentrate composition 100.

TABLE 1

| | Composition in percentage |
|---|---|
| Ingredients | by weight (% w/w) |
| Sugar | 2-3 |
| Powdered tea | 4-6 |
| Orange peach fruit | 20-21 |
| Pineapple juice | 5-6 |
| Water/Aqua | 60-61 |
| Mango or Peach juice | 4-6 |

To dilute the composition 100 for human consumption, the composition 100 is diluted with about 55% by weight to about 56% by weight water/aqua 116. The water 116 is preferably distilled water but can also be tap water. In other embodiments, 84 oz of water 116 can be added to dilute the concentrated composition 100.

Table 2 below shows the approximate concentrations of various components in the frozen tea beverage concentrate composition 100, in accordance preferred embodiments. Preferably, the fruit flavor can be natural mango juice or natural peach juice.

TABLE 2

| | Composition in percentage |
|---|---|
| Ingredients | by weight (% w/w) |
| Sugar | 1-3 |
| Powdered tea | 5-8 |
| Orange peach fruit | 16-23 |
| Pineapple juice | 4-7 |
| Water/Aqua | 50-71 |
| Fruit flavor | 5-8 |

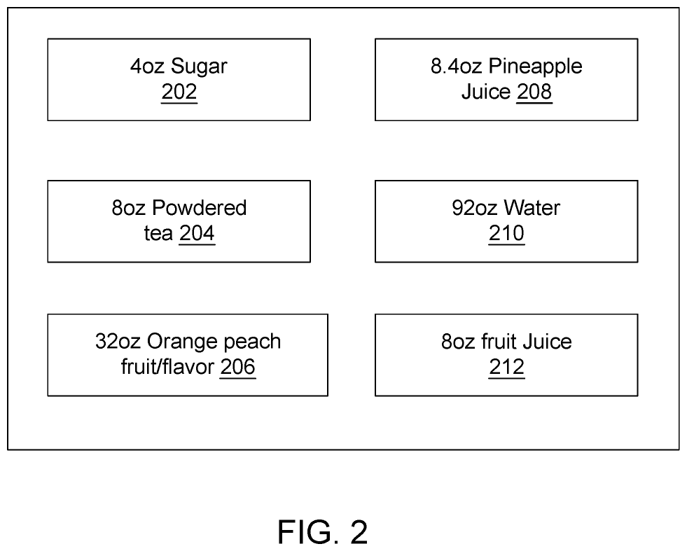

Referring now to FIG. 2, in another embodiment, the frozen tea beverage concentrate composition 100 includes 4 oz sugar 202, 8 oz powdered tea 204, 32 oz orange peach flavor 206, 8.4 oz pineapple juice 208, 92 oz water 210, and 8 oz fruit juice 212 which is preferably mango juice or peach juice. The composition 100 is preferably stored in a refrigerator for freezing at zero degree (0°) Celsius, or thirty-two degree (32°) Fahrenheit, wherein the composition 100 is kept in the refrigerator for at least two hours.

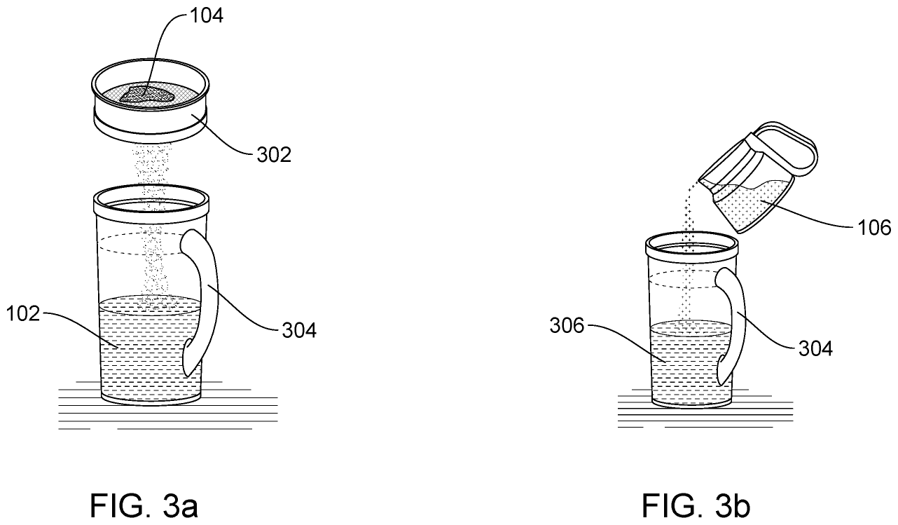

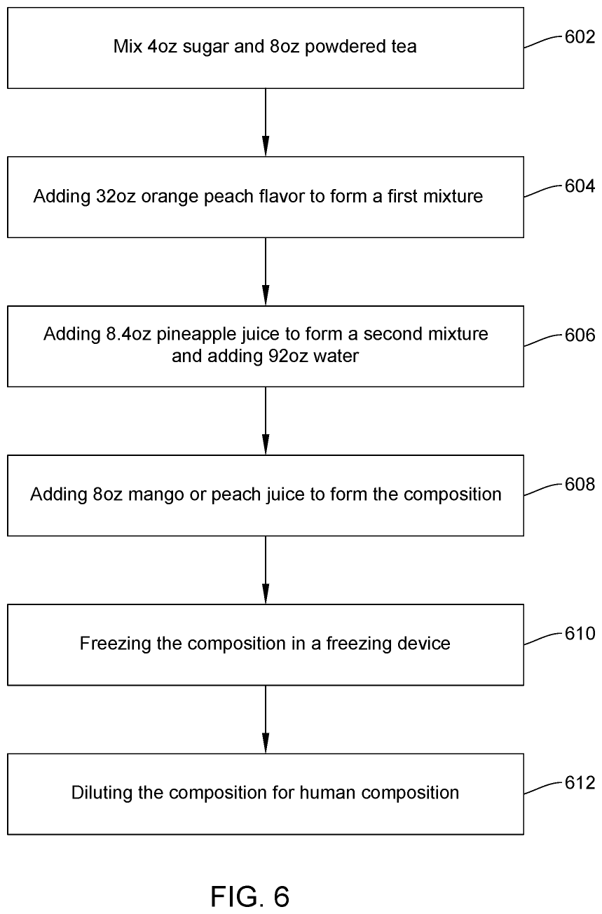

FIG. 3a illustrates a perspective view of adding powdered tea 104 to the proportioned sugar 102, in accordance with embodiments of the invention. Preferably, the powdered tea 104 includes granules or particles which are passed through the U.S. mesh sieve number 40 302 to mix with the sugar 102, which can be white sugar or brown sugar, and stored in a mixing container 304. The U.S. mesh sieve number 40 302 and the mixing container 304 can be of different sizes and shapes. As used herein, references to U.S. mesh sieve number 40 means the 40 mesh is a medium size U.S. Standard mesh size with a 0.0165″ (425 μm) nominal sieve opening with a typical wire diameter of 0.28 mm. Then, orange peach flavor 106 is preferably added to form the first mixture 306, as illustrated in FIG. 3b and as further exemplified at Step 604 in FIG. 6.

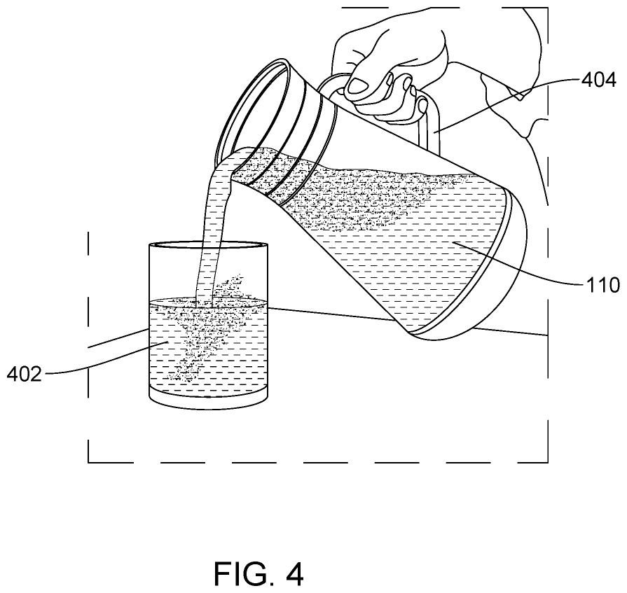

FIG. 4 illustrates a perspective view of mixing water in the second mixture, in accordance with embodiments of the invention. The first mixture 306 is added with the 8.4 oz pineapple juice to form a second mixture 402 to which 92 oz water 110 is mixed using the container 404 to dilute the taste and increase the quantity of the second mixture 402. Similarly, 8 oz mango or peach juice is preferably added to the second mixture 402 to form the composition 100 in accordance with a preferred embodiment.

FIG. 5 illustrates a perspective view of freezing the composition to produce frozen tea concentrate beverage composition 100, in accordance with embodiments of the invention. A freezing device 502, preferably in the form of a refrigerator, is used for freezing the composition 100. The composition 100 is preferably kept in a gallon pitcher 504 when freezing the composition inside of the freezing device 502, as illustrated in FIG. 5. Further, the composition 100 is preferably pureed before freezing. Further, the freezing process takes about 40-45 minutes to achieve a slushy state and takes about 2 hours to achieve a frozen state.

In another embodiment, a fruit beverage concentrate composition can have the same composition as of the frozen tea beverage concentrate composition 100. The fruit beverage concentrate composition includes sugar 102, powdered tea 104, orange peach fruit/flavor 106, pineapple juice 108, water 110, and one of mango 112 or peach juice 114. The fruit beverage concentrate composition is suitable for human composition and can be diluted using additional water 110 for such consumption. The fruit beverage concentrate composition can be frozen in a freezing device 502 for at least a predetermined time period, such as two hours, and the fruit beverage concentrate composition is preferably pureed before being placed inside of the freezing device 502 for freezing.

As shown in FIG. 5, the composition 100 is preferably stored in a storage device such as a gallon pitcher 504 that is placed inside of the freezing device 502 (preferably for at least two hours) for freezing the composition 100.

It will be apparent to a person skilled in the art that the composition 100 can be manufactured either manually or automatically and can be used for both personal and commercial use. Shelf life means how long a drink can maintain its optimal quality under specific or expected home or store display conditions. Through embodiments disclosed herein, the disclosed frozen tea beverage concentrate composition 100 includes an improved shelf life over conventional frozen tea concentrates. Accordingly, this means that a tea beverage that is produced by, for instance, thawing and adding water to the disclosed frozen tea beverage concentrate composition 100 exhibits uncompromised flavor profiles, improved aromas, and improved health benefits, including after a longer period of storage, than is achieved tea beverages produced with conventional frozen tea concentrates.

Referring now to FIG. 6, for making the composition 100, initially, 4 oz sugar 102 is mixed with 8 oz powdered tea 104 as illustrated in FIG. 3a (Step 602 of FIG. 6). Then, 32 oz orange peach flavor is added to form the first mixture 306 (Step 604 of FIG. 6), as illustrated in FIG. 3b. Thereafter, 8.4 oz pineapple juice 108 is added to the first mixture to form the second mixture 402 and is preferably mixed well with 92 oz water 210 (Step 606 of FIG. 6). According to the preferences of a user, 8 oz mango or peach juice is added to form the composition (Step 608), and the composition 100 is stored inside of a refrigerator 502 for about two hours in order to chill and then freeze (Step 610) the composition 100. The chilling process takes about 40-45 minutes to achieve a slushy state, and the chilling and freezing process takes about 2 hours for the composition 100 to achieve a frozen state. Finally, for using the composition for human consumption, 84 oz water is preferably added to dilute the frozen composition (Step 612 of FIG. 6).

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A fruit beverage concentrate composition suitable for thawing and dilution to generate a beverage suitable for human consumption, said composition consisting of:
2%-3% by weight sugar;
4%-6% by weight powdered tea;
20%-21% by weight orange peach fruit;
5%-6% by weight pineapple juice;
60%-61% by weight water;
4%-6% by weight mango or peach juice; and
wherein the fruit beverage concentrate composition is pureed and frozen in a freezing device for at least two hours.

2. The fruit beverage concentrate composition of claim 1, wherein the composition is diluted with about 55% by weight to about 56% by weight water to prepare the beverage suitable for human consumption.

3. The fruit beverage concentrate composition of claim 1, wherein the sugar is selected from a group consisting of white sugar and brown sugar, wherein said sugar is in the form of granules.

4. The fruit beverage concentrate composition of claim 1, wherein the powdered tea consists of particle sizes such that said 4%-6% by weight pass through a U.S. mesh sieve number 40.

5. The fruit beverage concentrate composition of claim 1, wherein the fruit beverage concentrate composition is frozen in a gallon pitcher, wherein the freezing device is a refrigerator.

6. The fruit beverage concentrate composition of claim 5, wherein said fruit beverage concentrate composition is adapted for dilution upon an addition of 84 oz distilled water to said fruit beverage concentrate composition for creating the beverage.

7. A frozen tea beverage concentrate composition consisting of:
4 oz sugar;
8 oz powdered tea;
32 oz orange peach flavor;
8.4 oz pineapple juice;
92 oz distilled water; and
8 oz mango or peach juice.

8. The frozen tea beverage concentrate composition of claim 7, wherein the concentration composition is chilled in a refrigerator for at least two hours to a point of freezing said concentrate composition.

9. The frozen tea beverage concentrate composition of claim 8, wherein said composition is adapted to be diluted with an addition of 84 oz water.

10. The frozen tea beverage concentrate composition of claim 8, wherein the concentration composition is pureed in a gallon pitcher before chilling in the refrigerator.

11. A frozen tea beverage concentrate composition, comprising:
about 1% by weight to about 3% by weight sugar;
about 5% by weight to about 8% by weight powdered tea;
about 16% by weight to about 23% by weight orange peach fruit;
about 4% by weight to about 7% by weight pineapple juice;
about 50% by weight to about 71% by weight water;
about 5% by weight to about 8% by weight a fruit flavor; and
wherein, the frozen tea beverage concentrate composition is pureed in a gallon pitcher and frozen in a freezing device for at least two hours adapted to be served as a diluted beverage by adding water to said frozen composition.

12. The frozen tea beverage concentrate composition of claim 11, wherein the fruit flavor is natural mango juice.

13. The frozen tea beverage concentrate composition of claim 11, wherein the fruit flavor is natural peach juice.

14. The frozen tea beverage concentrate composition of claim 11, wherein the composition achieves a slushy state in 45 minutes in the freezing device.

15. The frozen tea beverage concentrate composition of claim 11, further comprising 84 oz water adapted to dilute the composition.

16. A method of making a frozen tea concentrate beverage composition adapted for thawing and dilution configured to generate a beverage suitable for human consumption, comprising:
providing 4 oz sugar, 8 oz powdered tea, 32 oz orange peach flavor, 8.4 oz pineapple juice,
92 oz water, and 8 oz mango or peach juice;
mixing 4 oz sugar with 8 oz powdered tea;
adding 32 oz orange peach flavor to form a first mixture;
adding 8.4 oz pineapple juice to form a second mixture and mixing the second mixture with 92 oz water;
adding 8 oz mango or peach juice to the second mixture to form the composition;
pouring the composition in a gallon pitcher;
placing the gallon pitcher in a freezing device for freezing the composition, wherein the composition freezes in a predetermined length of time; and
diluting the frozen composition by adding water thereto for human consumption.

17. The method of making a frozen tea concentrate beverage composition of claim 16, wherein the composition is diluted by mixing about 55% by weight to about 56% by weight water adapted to prepare the beverage suitable for human consumption.

18. The method of making a frozen tea concentrate beverage composition of claim 16, wherein the frozen tea concentrate beverage composition is pureed in the gallon pitcher before chilling in the freezing device.

19. The method of making a frozen tea concentrate beverage composition of claim 16, wherein the sugar is selected from a group consisting of white sugar and brown sugar, wherein said sugar is in the form of granules.

20. The method of making a frozen tea concentrate beverage composition of claim 16, further comprising pouring the powdered tea through a sieve consisting of U.S. mesh sieve number 40 wherein the powdered tea is 4%-6% by weight and consists of particle sizes passed through said U.S. mesh sieve number 40.

21. The method of making a frozen tea concentrate beverage composition of claim 16, wherein the predetermined length of time is at least 2 hours.
